(19) United States
(12) Patent Application Publication
(10) Pub. No.: US 2025/0284516 A1
(43) Pub. Date: Sep. 11, 2025

(54) MIGRATION OF VIRTUAL MACHINE DATA BETWEEN DISTINCT STORAGE ENVIRONMENTS

(71) Applicant: Dell Products L.P., Round Rock, TX (US)

(72) Inventors: Dan Aharoni, Brookline, MA (US); Jehuda Shemer, Kfar Saba (IL); Arieh Don, Newton, MA (US); Christopher Trudel, Florence, TX (US)

(21) Appl. No.: 18/601,418

(22) Filed: Mar. 11, 2024

(51) Int. Cl. G06F 9/455

(52) U.S. Cl. CPC G06F 9/45558; G06F 2009/4557; G06F 2009/45579

(57) ABSTRACT

An apparatus includes at least one processing device comprising a processor coupled to a memory. The at least one processing device is configured to obtain index node information for a set of virtual machine data of a particular virtual machine in a source domain comprising a source storage system, to utilize the index node information to identify locations of respective blocks of the set of virtual machine data among other blocks present in a first storage volume of the source storage system, to map the blocks of the set of virtual machine data to a second storage volume of the source storage system based at least in part on their respective locations in the first storage volume, and to migrate the second storage volume comprising the mapped blocks of the set of virtual machine data to a target storage system of a target domain. The migration illustratively uses asynchronous replication.

### FIELD

The field relates generally to information processing systems, and more particularly to storage in information processing systems.

### BACKGROUND

Storage arrays and other types of storage systems are typically accessed by host devices over a network. Applications running on the host devices each include one or more processes that issue input-output (IO) operations directed to particular logical storage volumes or other logical storage devices, for delivery by the host devices over selected paths to storage ports of the storage system. Various types of storage access protocols can be used by host devices to access the logical storage volumes or other logical storage devices of the storage system, including by way of example Small Computer System Interface (SCSI) storage access protocols and Non-Volatile Memory Express (NVMe) storage access protocols. The host devices may each illustratively comprise one or more virtual machines, with each of the virtual machines having associated virtual machine data, in some cases referred to as virtual machine disks or VMDKs. Unfortunately, difficulties can arise under conventional practice when attempting to migrate VMDKs or other virtual machine data from one storage environment to another, such as from an enterprise storage system to a cloud-based storage system.

### SUMMARY

Illustrative embodiments provide techniques for highly accurate and efficient migration of VMDKs or other types and arrangements of virtual machine data between distinct storage environments, such as, for example, between an enterprise storage system and a cloud-based storage system, although the disclosed techniques are more generally applicable to any of a wide variety of other storage environments.

In one embodiment, an apparatus comprises at least one processing device that includes a processor coupled to a memory. The at least one processing device is configured to obtain index node information for a set of virtual machine data of a particular virtual machine in a source domain comprising a source storage system, to utilize the index node information to identify locations of respective blocks of the set of virtual machine data among other blocks present in a first storage volume of the source storage system, to map the blocks of the set of virtual machine data to a second storage volume of the source storage system based at least in part on their respective locations in the first storage volume, and to migrate the second storage volume comprising the mapped blocks of the set of virtual machine data to a target storage system of a target domain.

The at least one processing device in some embodiments comprises at least a portion of the source storage system.

Additionally or alternatively, the at least one processing device in some embodiments may comprise at least a portion of a host device coupled to at least one of the source storage system and the target storage system.

In some embodiments, at least portions of the blocks of the set of virtual machine data are arranged in the first storage volume in a non-contiguous manner but in a particular ordering relative to one another, and further wherein all of the blocks of the set of virtual machine data are arranged in the second storage volume in a contiguous manner and are also arranged in the second storage volume in a manner that preserves the particular ordering of the blocks relative to one another from the first storage volume.

The set of virtual machine data for the particular virtual machine illustratively comprises a VMDK of the particular virtual machine, although numerous other types and arrangements of virtual machine data can be used.

Additionally or alternatively, the first storage volume in some embodiments is configured in accordance with a virtual machine file system (VMFS) of the source storage system and includes the blocks of the set of virtual machine data interspersed with blocks of one or more other sets of virtual machine data of other virtual machines in the source domain.

In some embodiments, migrating the second storage volume comprising the mapped blocks of the set of virtual machine data to the target storage system of the target domain comprises configuring a replication process to replicate the second storage volume comprising the mapped blocks of the set of virtual machine data to an additional storage volume of the target storage system of the target domain.

By way of example, the replication process in some embodiments comprises a cycle-based asynchronous replication process in which differential data between consecutive snapshots of the second storage volume is replicated to the additional storage volume for each of a plurality of cycles.

In some embodiments, the blocks of the set of virtual machine data have a first block size in the first storage volume and are mapped on a one-to-one basis to respective corresponding blocks of the same block size in the second storage volume. Other embodiments can utilize different block sizes and corresponding different types of mappings that involve mapping multiple blocks of the set of virtual machine data to each block in the second storage volume, or mapping different portions of a given block of the set of virtual machine data to respective different blocks in the second storage volume.

In some embodiments, the at least one processing device is further configured to detect a condition indicative of a change in a block layout of the blocks of the set of virtual machine data in the first storage volume, and to repeat at least a portion of the obtaining, utilizing, mapping and migrating responsive to the detected condition.

Additionally or alternatively, the obtaining, utilizing, mapping and migrating are repeated in some embodiments for each of one or more additional sets of virtual machine data of one or more respective additional virtual machines in the source domain comprising the source storage system. In one or more of such embodiments, instances of the second storage volume corresponding to respective ones of the sets of virtual machine data collectively form at least a portion of a consistency group for migration to the target storage system of the target domain.

These and other illustrative embodiments include, without limitation, apparatus, systems, methods and computer program products comprising processor-readable storage media.

### BRIEF DESCRIPTION OF THE DRAWINGS

FIG. 1 is a block diagram of an information processing system configured with functionality for migration of virtual machine data in an illustrative embodiment.

FIG. 2 is a flow diagram of an example process for migration of virtual machine data in an illustrative embodiment.

FIG. 3 illustrates the operation of an example information processing system in performing migration of virtual machine data in one embodiment.

FIG. 4 shows a detailed example of a mapping of blocks of a set of virtual machine data between a first storage volume and a second storage volume of a source domain for migration to an additional storage volume of a target domain in an illustrative embodiment.

### DETAILED DESCRIPTION

Illustrative embodiments will be described herein with reference to exemplary information processing systems and associated computers, servers, storage devices and other processing devices. It is to be appreciated, however, that these and other embodiments are not restricted to the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other cloud-based system that includes one or more clouds hosting multiple tenants that share cloud resources, as well as other types of systems comprising a combination of cloud and edge infrastructure. Numerous different types of enterprise computing and storage systems are also encompassed by the term “information processing system” as that term is broadly used herein.

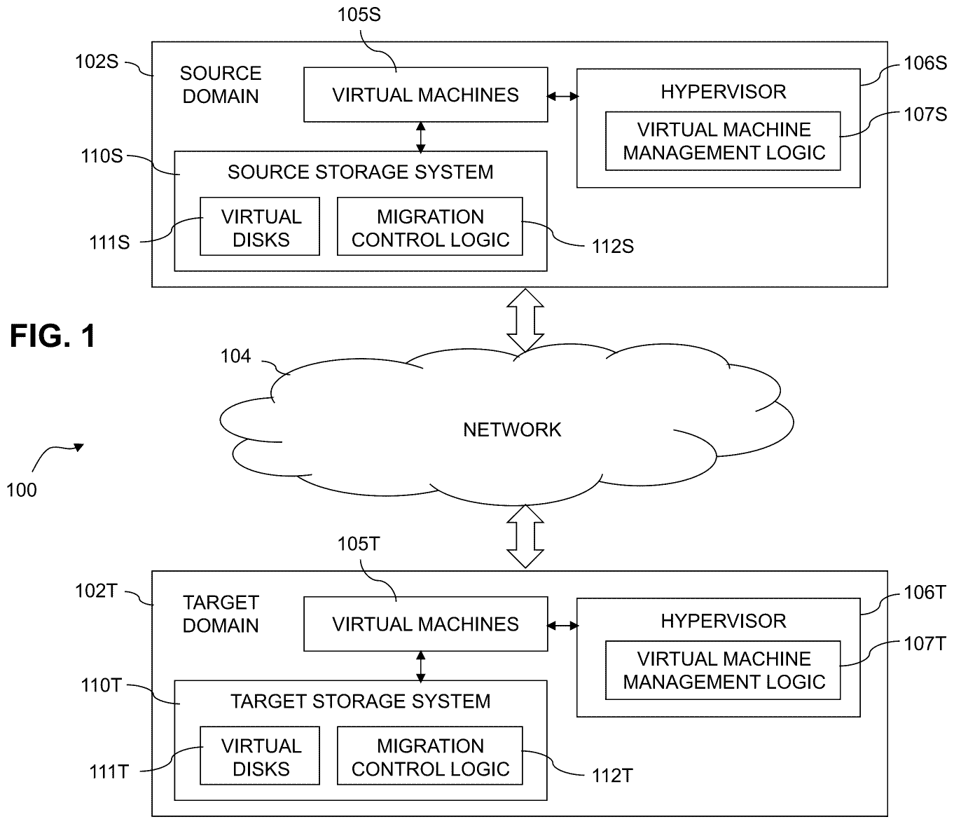

FIG. 1 shows an information processing system 100 configured in accordance with an illustrative embodiment. The information processing system 100 comprises a source domain 102S and a target domain 102T, collectively domains 102, which are configured to communicate with one another over a network 104. The source and target domains 102 are more particularly configured in this embodiment to participate in virtual machine data migration process in which one or more sets of virtual machine data associated with one or more respective virtual machines are migrated from the source domain 102S into the target domain 102T.

The domains 102 in the FIG. 1 embodiment are assumed to be implemented using at least one processing platform, with each such processing platform comprising one or more processing devices, and each such processing device comprising a processor coupled to a memory. Such processing devices can illustratively include particular arrangements of compute, storage and network resources. Such resources illustratively comprise one or more host devices and one or more associated storage systems.

The host devices illustratively support virtual resources such as virtual machines. Other types of virtual resources that may be supported in some embodiments include Linux containers (LXCs), or combinations of both as in an arrangement in which Docker containers or other types of LXCs are configured to run on virtual machines.

The host devices of a given one of the domains 102 illustratively comprise servers or other types of computers of an enterprise computer system, a cloud-based computer system or other arrangement of compute nodes.

As a more particular example, the host devices of a particular one of the domains 102 in some embodiments illustratively comprise respective ESX servers or other types of servers of an ESX environment or other type of host environment.

The host devices in some embodiments illustratively provide compute services such as execution of one or more applications on behalf of each of one or more system users. The applications illustratively involve writing data to and reading data from the one or more associated storage systems.

The term “user” herein is intended to be broadly construed so as to encompass numerous arrangements of human, hardware, software or firmware entities, as well as combinations of such entities. Compute and/or storage services may be provided for users under a Platform-as-a-Service (PaaS) model, an Infrastructure-as-a-Service (IaaS) model, a Function-as-a-Service (FaaS) model and/or a Storage-as-a-Service (SaaS) model, although it is to be appreciated that numerous other cloud infrastructure arrangements could be used. Also, illustrative embodiments can be implemented outside of the cloud infrastructure context, as in the case of a stand-alone computing and storage system implemented within a given enterprise.

In some embodiments, the domains 102 are associated with respective distinct storage environments, such as, for example, an enterprise storage system and a cloud-based storage system, although the disclosed techniques are more generally applicable to any of a wide variety of other storage environments.

The domains 102 in some embodiments are part of the same processing platform, and in other embodiments are part of respective distinct processing platforms. For example, the domains 102 can represent respective different parts of a given data center, or can represent respective different data centers.

Accordingly, distributed implementations of the system 100 are possible, in which certain components of the system reside in one data center in a first geographic location while other components of the system reside in one or more other data centers in one or more other geographic locations that are potentially remote from the first geographic location. The domains 102 can additionally or alternatively be part of cloud infrastructure such as various types of cloud-based systems.

A wide variety of other arrangements involving one or more processing platforms are possible. The term “processing platform” as used herein is therefore intended to be broadly construed so as to encompass, by way of illustration and without limitation, multiple sets of processing devices that are configured to communicate over one or more networks.

The network 104 is assumed to comprise a portion of a global computer network such as the Internet, although other types of networks can be part of the network 104, including a wide area network (WAN), a local area network (LAN), a satellite network, a telephone or cable network, a cellular network such as a 4G or 5G cellular network, a wireless network such as a WiFi or WiMAX network, or various portions or combinations of these and other types of networks. The network 104 in some embodiments therefore comprises combinations of multiple different types of networks each comprising processing devices configured to communicate using Transmission Control Protocol (TCP), Internet Protocol (IP) and/or other communication protocols.

As a more particular example, some embodiments may utilize one or more high-speed local networks in which associated processing devices communicate with one another utilizing Peripheral Component Interconnect express (PCIe) interface cards of those devices, that support networking protocols such as InfiniBand or Fibre Channel, in addition to or in place of TCP/IP.

Numerous alternative networking arrangements are possible in a given embodiment, as will be appreciated by those skilled in the art. Additional examples include remote direct memory access (RDMA) over Converged Ethernet (RoCE) or RDMA over iWARP.

The source domain 1025 comprises a plurality of virtual machines 1055 and an associated hypervisor 1065. The virtual machines 1055 comprise particular arrangements of compute, storage and network resources. For example, a given one of the virtual machines 1055 illustratively comprises a designated combination of compute, storage and network resources, such as a set of one or more virtual central processing units (CPUs), one or more virtual storage drives and one or more virtual network interface cards (NICs). Other types and configurations of virtual machines can be used in other embodiments, and the term “virtual machine” as used herein is intended to be broadly construed.

Each of the virtual machines 105S is illustratively associated with a particular set of virtual machine data, such as a virtual machine “disk” or VMDK. Such VMDKs are stored in a source storage system 110S of the source domain 102S, and are also referred to in this embodiment as virtual disks 1115. The source storage system 110S further implements migration control logic 112S as shown.

Similarly, the target domain 102T comprises a plurality of virtual machines 105T and an associated hypervisor 106T. The virtual machines 105T comprise particular arrangements of the above-noted compute, storage and network resources. Like the virtual machines 105S, each of the virtual machines 105T is illustratively associated with a particular set of virtual machine data, such as a virtual machine “disk” or VMDK. Such VMDKs are stored in a target storage system 110T of the target domain 102T, and are also referred to in this embodiment as virtual disks 111T. The target storage system 110T further implements migration control logic 112T as shown.

The virtual machines 1055 and 105T of the respective source and target domains 102S and 102T are collectively referred to herein as virtual machines 105. Hypervisors 106S and 106T are likewise collectively referred to as hypervisors 106, and source and target storage systems 110S and 110T are collectively referred to as storage systems 110. Also, virtual disks 111S and 111T are collectively referred to as virtual disks 111, and migration control logic 1125 and 112T are collectively referred to as migration control logic 112.

The compute resources utilized by virtual machines 105 illustratively comprise portions of sets of processing cores and associated electronic memory components. For example, in a distributed arrangement comprising multiple nodes, each such node can comprise a separate set of processing cores and associated electronic memory components, different portions of which are allocated to different ones of the virtual machines 105 by its corresponding one of the hypervisors 106. An example of a hypervisor platform that may be used to implement hypervisors 106 within the system 100 is VMware® vSphere® which may have an associated virtual infrastructure management system such as the VMware® vCenter™. The underlying physical machines may comprise one or more distributed processing platforms that each include multiple physical processing devices each comprising at least one processor coupled to a memory. Numerous other arrangements of compute resources are possible.

The storage resources utilized by virtual machines 105 illustratively comprise portions of one or more storage systems, such as one or more PowerFlex® distributed storage systems and/or one or more PowerMax™ or PowerStore™ storage arrays, commercially available from Dell Technologies Inc. A wide variety of other types of storage systems can be used in implementing the domains 102 in other embodiments, including, by way of example, software-defined storage, cloud storage, object-based storage and scale-out storage. Combinations of multiple ones of these and other storage types can also be used in implementing a given storage system in an illustrative embodiment.

The storage devices of such storage systems illustratively comprise solid state drives (SSDs). Such SSDs are implemented using non-volatile memory (NVM) devices such as flash memory. Other types of NVM devices that can be used to implement at least a portion of the storage devices include non-volatile random access memory (NVRAM), phase-change RAM (PC-RAM), magnetic RAM (MRAM), resistive RAM, and spin torque transfer magneto-resistive RAM (STT-MRAM). These and various combinations of multiple different types of NVM devices may also be used. For example, hard disk drives (HDDs) can be used in combination with or in place of SSDs or other types of NVM devices.

Storage systems in some embodiments can utilize command features and functionality associated with NVM Express (NVMe), as described in the NVM Express Base Specification, Revision 2.0c, October 2022, and its associated NVM Express Command Set Specification and NVM Express TCP Transport Specification, all of which are incorporated by reference herein. Other storage protocols of this type that may be utilized in illustrative embodiments disclosed herein include NVMe over Fabric, also referred to as NVMe-oF, and NVMe over Transmission Control Protocol (TCP), also referred to as NVMe/TCP. Additional examples of storage access protocols that can be used in illustrative embodiments disclosed herein include the Small Computer System Interface (SCSI) storage access protocol and the Internet SCSI (iSCSI) storage access protocol.

It is to be appreciated that other types of storage devices can be used in other embodiments. For example, a given storage system can include a combination of different types of storage devices, as in the case of a multi-tier storage system comprising an NVM-based fast tier and a disk-based capacity tier. In such an embodiment, each of the fast tier and the capacity tier of the multi-tier storage system comprises a plurality of storage devices with different types of storage devices being used in different ones of the storage tiers. For example, the fast tier may comprise flash drives while the capacity tier comprises HDDs. The particular storage devices used in a given storage tier may be varied in other embodiments, and multiple distinct storage device types may be used within a single storage tier. The term “storage device” as used herein is intended to be broadly construed, so as to encompass, for example, SSDs, HDDs, flash drives, hybrid drives or other types of storage devices. The term “storage system” as used herein is also intended to be broadly construed, and should not be viewed as being limited to any particular type or configuration of storage system.

Different portions of storage resources of the type described above are allocated to different ones of the virtual machines 105 by its corresponding one of the hypervisors 106. For example, each of the virtual machines 105 is illustratively allocated a set of logical storage volumes each corresponding to a different logical unit (LUN) or NVMe namespace. Numerous other arrangements of storage resources are possible.

The network resources utilized by virtual machines 105 illustratively comprise portions of one or more sets of network interfaces, possibly of different types supporting respective different communication protocols within system 100. For example, in a distributed arrangement comprising multiple nodes, each such node can comprise a separate set of NICs or other types of network interfaces, different portions of which are allocated to different ones of the virtual machines 105 by its corresponding one of the hypervisors 106. Numerous other arrangements of network resources are possible.

The hypervisor 106S of source domain 102S in the FIG. 1 embodiment includes virtual machine management logic 107S. Similarly, the hypervisor 106T of target domain 102T includes virtual machine management logic 107T.

The instances of virtual machine management logic 107S and 107T are collectively referred to herein as virtual machine management logic 107, and provide functionality such as creating, configuring, running, monitoring, breaking down and otherwise managing their respective corresponding sets of virtual machines 105.

The hypervisors 106 of the domains 102 may include additional modules and other components typically found in conventional implementations of such hypervisors, although such additional modules and other components are omitted from the figure for clarity and simplicity of illustration.

The hypervisors 106 may illustratively comprise, for example, respective VMware® ESX hypervisors, Microsoft Hyper-V hypervisors, kernel-based virtual machine (KVM) hypervisors, Xen hypervisors, and other types of hypervisors. The term “hypervisor” as used herein is therefore intended to be broadly construed.

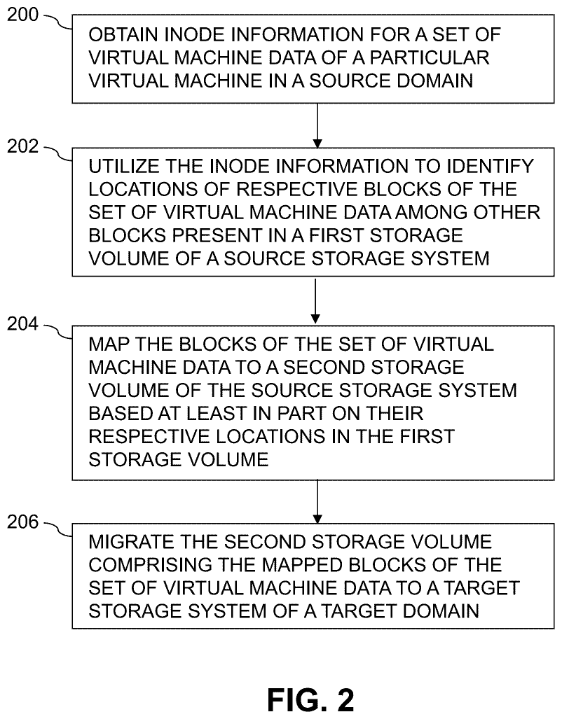

The instances of migration control logic 112 in the respective source and target domains 102 illustratively provide at least a portion of a “migrator” or “migration engine” of the system 100, configured to implement a virtual machine data migration process carried out between the domains 102, such as the virtual machine data migration process to be described below in conjunction with the flow diagram of FIG. 2.

An exemplary virtual machine data migration process more particularly comprises a migration process in which a VMDK or other set of virtual machine data of a particular one of the virtual machines in the set of virtual machines 1055 is migrated from the source domain 1025 to the target domain 102T for utilization by a particular one of the virtual machines in the set of virtual machines 105T. Other types of migration arrangements, each possibly involving more than one virtual machine, can be used in other embodiments.

These and other operations relating to migration of virtual machine data are illustratively implemented at least in part by or otherwise under the control of the source and target instances of migration control logic 112. One or more such operations can be additionally or alternatively controlled by one or more other system components in other embodiments. Also, although shown in FIG. 1 as being implemented within the source and target storage systems 110, the instances of migration control logic 112 in other embodiments can additionally or alternatively be implemented at least in part on one or more of the hypervisors 106 and/or in other components of at least one of the source and target domains 102.

As indicated above, difficulties can arise under conventional practice when attempting to migrate VMDKs or other virtual machine data from one storage environment to another, such as from an enterprise storage system to a cloud-based storage system.

For example, it can be difficult under conventional practice to migrate virtual machine data between different storage environments that may be associated with different virtual machine management domains. Different types of virtual machine installations may have different types of management domains. In the case of a VMware® vCenter™ managing ESX hypervisors, a management domain in some embodiments may comprise a data center, while in the case of a Microsoft System Center Virtual Machine Manager (SCVMM) managing Microsoft Hyper-V hypervisors, the management domain may comprise a host group. These are examples of domains 102 in some embodiments, and additional or alternative domains 102 can be used in these and other embodiments. Migration of virtual machine data between source and target domains 102 in other embodiments may comprise, for example, migration of virtual machine data from an on-premises cloud to a public cloud or vice versa, and numerous other arrangements. Terms such as “source domain” and “target domain” as used herein are therefore intended to be broadly construed.

Illustrative embodiments overcome these and other disadvantages of conventional practice by providing techniques for highly accurate and efficient migration of VMDKs or other types and arrangements of virtual machine data between distinct storage environments, such as, for example, between an enterprise storage system and a cloud-based storage system. These distinct storage environments may be associated with respective distinct virtual machine management domains, although the disclosed techniques are more generally applicable to any of a wide variety of other storage environments.

Aspects of migration of virtual machine data implemented in information processing system 100 will now be described in greater detail.

In some embodiments, the target storage system 110T is a remote storage system relative to the source storage system 110S. For example, the source storage system 110S may be an enterprise storage system and the target storage system 110T may be a cloud-based storage array or other type of cloud-based storage system. A wide variety of different types of domains 102 can be supported in other embodiments.

The above-described virtual machine data migration functionality is illustratively implemented in the system 100 in the following manner.

The system 100 illustratively comprises at least one processing device that includes a processor coupled to a memory. The at least one processing device is configured to obtain index node (“Inode”) information for a set of virtual machine data of a particular one of the virtual machines 105S in the source domain 102S comprising the source storage system 110S, to utilize the index node information to identify locations of respective blocks of the set of virtual machine data among other blocks present in a first storage volume of the source storage system 110S, to map the blocks of the set of virtual machine data to a second storage volume of the source storage system 110S based at least in part on their respective locations in the first storage volume, and to migrate the second storage volume comprising the mapped blocks of the set of virtual machine data to the target storage system 110T of the target domain 102T. The migrated second storage volume is illustratively utilizable by a particular one of the virtual machines 105T of the target domain 102T.

The at least one processing device in some embodiments comprises at least a portion of the source storage system 110S. It may also include at least a portion of the target storage system 110T in some embodiments.

Additionally or alternatively, the at least one processing device in some embodiments may comprise at least a portion of a host device coupled to at least one of the source storage system 110S and the target storage system 110T.

In some embodiments, at least portions of the blocks of the set of virtual machine data are arranged in the first storage volume in a non-contiguous manner but in a particular ordering relative to one another. In addition, all of the blocks of the set of virtual machine data are arranged in the second storage volume in a contiguous manner and are also arranged in the second storage volume in a manner that preserves the particular ordering of the blocks relative to one another from the first storage volume.

The first storage volume illustratively comprises a particular one of the virtual disks 111S of the source storage system 110S. The second storage volume is migrated to the target storage system 110T and illustratively comprises a corresponding one of the virtual disks 111T of the target storage system 110T.

In some embodiments, host devices illustratively comprise respective ESX servers commercially available from VMware® where the ESX servers utilize a virtual machine file system (VMFS). Such ESX servers, as the term “ESX” is broadly used herein, should be understood to generally encompass other related types of servers, such as ESXi servers. VMFS is illustratively configured as a cluster file system that facilitates storage virtualization for multiple ESX servers. It is to be appreciated, however, that references herein to particular host device and host file system types, such as ESX servers and VMFS, are presented for purposes of illustration only. A wide variety of other types of host devices and host file systems can be used to implement virtual machines and associated sets of virtual machine data in other embodiments.

The set of virtual machine data for the particular virtual machine illustratively comprises a VMDK of the particular virtual machine, although numerous other types and arrangements of virtual machine data can be used.

Additionally or alternatively, the first storage volume in some embodiments is configured in accordance with a VMFS of the source storage system 110s and includes the blocks of the set of virtual machine data interspersed with blocks of one or more other sets of virtual machine data of other virtual machines in the source domain 1025.

In some embodiments, migrating the second storage volume comprising the mapped blocks of the set of virtual machine data to the target storage system 110T of the target domain 102T comprises configuring a replication process to replicate the second storage volume comprising the mapped blocks of the set of virtual machine data to an additional storage volume of the target storage system 110T of the target domain 102T.

By way of example, the replication process in some embodiments comprises a cycle-based asynchronous replication process in which differential data between consecutive snapshots of the second storage volume is replicated to the additional storage volume for each of a plurality of cycles. A given such asynchronous replication process illustratively operates over multiple sequential intervals, each corresponding to a cycle, and for each interval transmits differential data that represent changed data of one or more logical storage volumes of a consistency group, relative to a previous interval. A replication process in some embodiments can include one or more replication sessions, each illustratively involving one or more source-target logical storage volume pairs or other types and arrangements of consistency groups. The term “replication process” as used herein is intended to be broadly construed, so as to encompass these and numerous other replication arrangements.

In some embodiments, the blocks of the set of virtual machine data have a first block size in the first storage volume and are mapped on a one-to-one basis to respective corresponding blocks of the same block size in the second storage volume. Other embodiments can utilize different block sizes and corresponding different types of mappings that involve mapping multiple blocks of the set of virtual machine data to each block in the second storage volume, or mapping different portions of a given block of the set of virtual machine data to respective different blocks in the second storage volume.

In some embodiments, the at least one processing device is further configured to detect a condition indicative of a change in a block layout of the blocks of the set of virtual machine data in the first storage volume, and to repeat at least a portion of the above-noted obtaining, utilizing, mapping and migrating responsive to the detected condition.

Additionally or alternatively, the obtaining, utilizing, mapping and migrating are repeated in some embodiments for each of one or more additional sets of virtual machine data of one or more respective additional virtual machines in the source domain 102S comprising the source storage system 110S. In one or more of such embodiments, instances of the second storage volume corresponding to respective ones of the sets of virtual machine data collectively form at least a portion of a consistency group for migration to the target storage system 110T of the target domain 102T.

These and other aspects of the virtual machine data migration functionality of the source and target domains 102 are illustratively performed at least in part by or under the control of respective storage controllers of the source and target storage systems 110 utilizing respective instances of migration control logic 112. Such a storage controller is considered an illustrative example of what is more generally referred to herein as “at least one processing device” comprising a processor coupled to a memory.

Accordingly, at least one processing device as that term is broadly used herein illustratively comprises at least a portion of the source storage system 110S, such as one or more storage controllers of the source storage system 110S, although numerous other arrangements of one or more processing devices, each comprising processor and memory components, are possible.

Again, the particular virtual machine data migration functionality described above can be varied in other embodiments. For example, the type and configuration of virtual machine data being migrated can be varied.

As indicated above, at least portions of the functionality for migration of virtual machine data in illustrative embodiments is implemented within or otherwise utilizing storage controllers of the source and target storage systems 110. For example, one or more such storage controllers are illustratively configured to control performance of one or more steps of the example process to be described below in conjunction with FIG. 2, utilizing associated instances of migration control logic 112.

Although one or more storage controllers are utilized to perform certain aspects of the functionality for migration of virtual machine data in some embodiments, this is by way of illustrative example only, and other embodiments need not utilize storage controllers in implementing such functionality. For example, additional or alternative logic circuitry and/or system components can be configured to implement aspects of the functionality for migration of virtual machine data in other embodiments.

It is to be appreciated that the above-described features of system 100 and other features of other illustrative embodiments are presented by way of example only, and should not be construed as limiting in any way. Accordingly, different numbers, types and arrangements of system components such as domains 102, networks 104, virtual machines 105, hypervisors 106, virtual machine management logic 107, storage systems 110, virtual disks 111 and migration control logic 112 can be used in other embodiments, as well as additional or alternative system components.

Accordingly, the particular sets of modules and other components implemented in the system 100 as illustrated in FIG. 1 are presented by way of example only. In other embodiments, only subsets of these components, or additional or alternative sets of components, may be used, and such components may exhibit alternative functionality and configurations. For example, as indicated previously, additional or alternative logic instances or other components implemented in the system 100 can be used to perform at least portions of the disclosed functionality for migration of virtual machine data.

The operation of the information processing system 100 will now be described in further detail with reference to the flow diagram of the illustrative embodiment of FIG. 2. The process as shown includes steps 200 through 206, and is suitable for use in conjunction with a replication process carried out between the source and target storage systems 110, but is more generally applicable to other types of information processing systems comprising source and target domains comprising respective source and target storage systems. In some embodiments, the process can involve one or more host devices in addition to the source and target storage systems of the respective source and target domains.

The steps of the FIG. 2 process are illustratively performed at least in part by or under the control of migration control logic instances that may be implemented in storage controllers of respective first and second storage systems, although other arrangements of system components can control or perform at least portions of one or more of the steps in other embodiments. The process may be viewed as an example of an algorithm implemented by the instances of migration control logic 112 in system 100.

In step 200, Inode information is obtained for a set of virtual machine data of a particular virtual machine in a source domain. It is to be appreciated that terms such as “index node” and “Inode” as used herein are intended to be broadly construed, so as to encompass a wide variety of different types and arrangements of information characterizing block layouts in one or more storage volumes. Also, Inode information can be obtained in various ways, such as through migration control logic of the source domain interacting with one or more ESX servers or other types of servers or virtualization management components in a given virtual machine deployment, for example, to read the Inode information therefrom. In some embodiments, the Inode information can be read directly from a corresponding storage volume of the storage domain, such as a first storage volume of the source domain. For example, a master file table (MFT) of a storage volume can identify which of a plurality of Inodes corresponds to which of a plurality of VMDKs that are stored in the storage volume. Again, numerous alternative arrangements for obtaining Inode information can be used.

In step 202, the Inode information is utilized to identify locations of respective blocks of the set of virtual machine data among other blocks present in a first storage volume of a source storage system. For example, the Inode information illustratively identifies, for a given set of virtual machine data comprising a particular VMDK, which blocks of the first storage volume are associated with that VMDK.

In step 204, the blocks of the set of virtual machine data are mapped to a second storage volume of the source storage system based at least in part on their respective locations in the first storage volume. In some embodiments, the first storage volume is part of a datastore having a VMFS file system, with at least portions of the blocks of the set of virtual machine data being arranged in the first storage volume in a non-contiguous manner but in a particular ordering relative to one another, illustratively comprising blocks of a particular VMDK interspersed with blocks of one or more other VMDKs. The mapping preserves the ordering of the blocks of the particular VMDK in the second storage volume. Accordingly, all of the blocks of the set of virtual machine data are arranged in the second storage volume in a contiguous manner and are also arranged in the second storage volume in a manner that preserves the particular ordering of the blocks relative to one another from the first storage volume.

In step 206, the second storage volume comprising the mapped blocks of the set of virtual machine data is migrated to a target storage system of a target domain. For example, in some embodiments, migrating the second storage volume comprising the mapped blocks of the set of virtual machine data to the target storage system of the target domain comprises configuring a replication process to replicate the second storage volume comprising the mapped blocks of the set of virtual machine data to an additional storage volume of the target storage system of the target domain. The replication process may more particularly comprise a cycle-based asynchronous replication process in which differential data between consecutive snapshots of the second storage volume is replicated to the additional storage volume for each of a plurality of cycles. Other migration arrangements can be used in other embodiments.

Steps 200 through 206 may be repeated for different source-target volume pairs, replication sessions, replication processes and/or consistency groups. A given such consistency group may comprise, for example, one or more logical storage volumes that are designated for replication from the source storage system to the target storage system.

The steps of the FIG. 2 process are shown in sequential order for clarity and simplicity of illustration only, and certain steps can at least partially overlap with other steps. Also, as indicated above, different instances of the FIG. 2 process can execute at least in part in parallel with one another for different source-target volume pairs, replication sessions, replication processes and/or consistency groups.

The particular processing operations and other system functionality described in conjunction with the flow diagram of FIG. 2 are presented by way of illustrative example only, and should not be construed as limiting the scope of the disclosure in any way. Alternative embodiments can use other types of processing operations involving host devices, storage systems and functionality for migration of virtual machine data. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement a plurality of different arrangements for migration of virtual machine data within a given information processing system.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

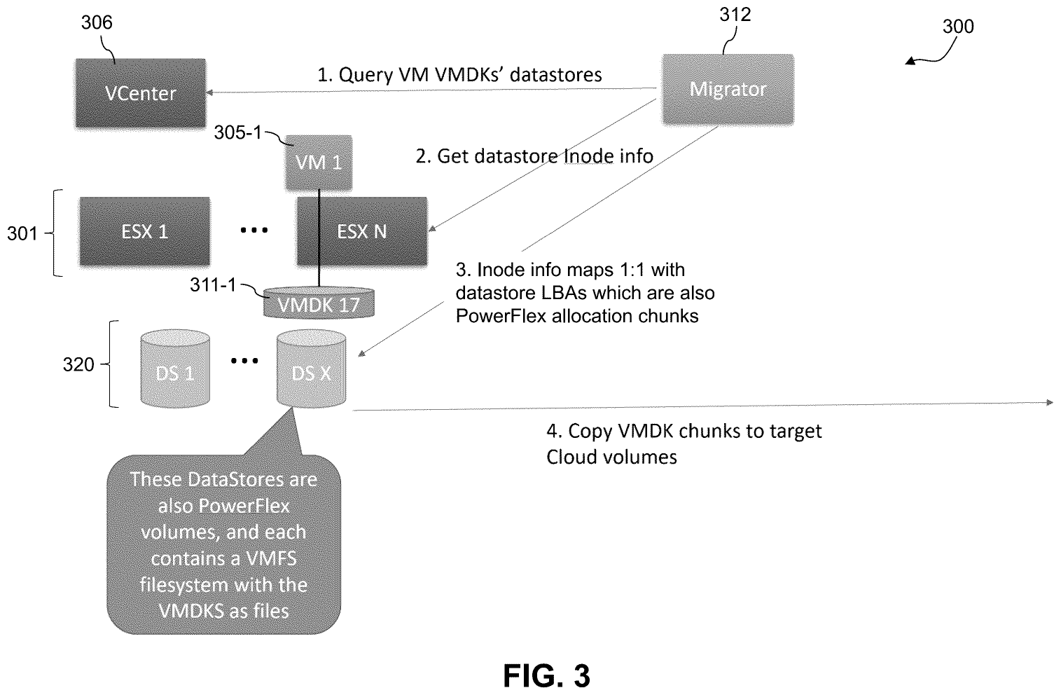

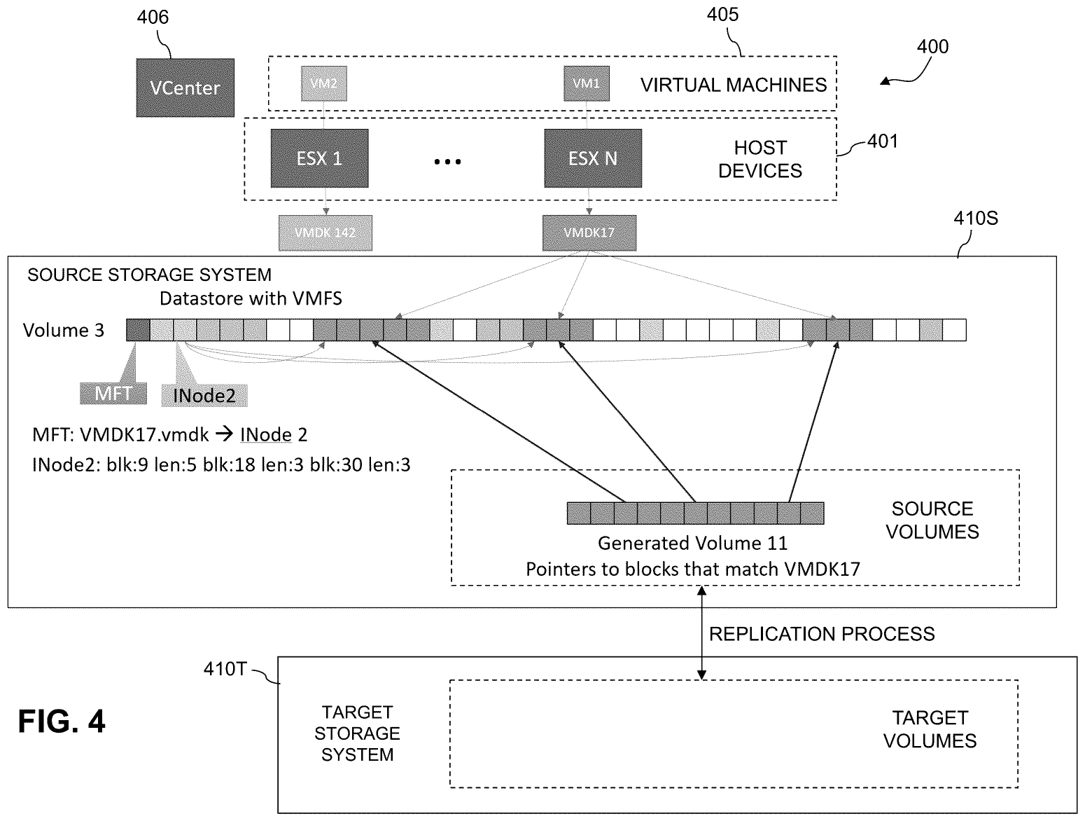

Additional illustrative embodiments implementing migration of virtual machine data between distinct storage environments will now be described with reference to the example systems of FIGS. 3 and 4.

As indicated above, the host devices may each illustratively comprise one or more virtual machines, with each of the virtual machines having associated virtual machine data, in some cases referred to as virtual machine disks or VMDKs. Also as mentioned previously, difficulties can arise under conventional practice when attempting to migrate VMDKs or other virtual machine data from one storage environment to another, such as from an enterprise storage system to a cloud-based storage system.

For example, in the case of a user that would like to migrate data from an enterprise storage system using ESX to a cloud-based storage system, the ESX datastore will typically comprise VMDKs that are stored as files in a VMFS file system. Such VMDKs stored as VMFS files generally cannot be directly migrated as such to other storage environments that are not based on ESX servers, such as a cloud-based storage system based on Linux servers.

The above-described illustrative embodiments advantageously overcome these and other drawbacks of conventional practice by providing techniques for highly accurate and efficient migration of VMDKs or other types and arrangements of virtual machine data between distinct storage environments, such as, for example, between an enterprise storage system and a cloud-based storage system, although the disclosed techniques are more generally applicable to any of a wide variety of other storage environments.

In some embodiments, a given enterprise or cloud-based storage system more particularly comprises a distributed storage system comprising a plurality of storage nodes. An example of such a distributed storage system is a PowerFlex® software-defined storage system from Dell Technologies Inc. PowerFlex® volumes can be used to implement an ESX datastore for enterprise host devices comprising ESX servers and can also be used to provide logical storage devices for host cloud-based host devices comprising Linux servers.

In some embodiments, a mapping of VMFS blocks of a given VMDK to respective chunks of a PowerFlex® volume is created, such that the resulting PowerFlex® volume comprising the VMDK can be directly replicated from a source storage system to a target storage system, illustratively using an asynchronous replication process.

Advantageously, such an approach can generate PowerFlex® volumes “on-the-fly” that correspond to respective ones of the VMDKs of the source storage environment, so as to allow the resulting PowerFlex® volumes to be directly migrated from the source storage environment to the target storage environment utilizing storage-based asynchronous replication of the PowerFlex® volumes that contain the respective VMDKs.

This avoids the drawbacks of conventional approaches, and considerably facilitates the migration of VMDKs or other types and arrangements of virtual machine data between distinct storage environments. For example, it can guarantee a VM-level consistency for VMDKs or other virtual machine data subject to online (“live”) migration between the distinct storage environments. Offline migration arrangements are also supported. In addition, multiple VMDKs or other sets of virtual machine data can be readily combined to form a consistency group for the migration between the distinct storage environments.

As indicated previously, the disclosed techniques can support migration from an ESX enterprise environment to a non-ESX cloud-based environment, but can also be used in a wide variety of other migration scenarios, including by way of example migration between an ESX enterprise environment to an on-premises Linux environment, from an ESX enterprise environment to another hypervisor-based environment such as a Hyper-V environment, and numerous others.

In some embodiments, an ESX datastore hosts a VMFS file system, on which files are created to represent VMDKs which are used by the VMs. The above-noted mapping specifies how the blocks of a particular VMDK map to chunks of a corresponding PowerFlex® volume. This allows the storage to be managed at the VMDK level for multiple VMDKs using respective PowerFlex® volumes.

The mapping in some embodiments provides a list of block addresses that can be extracted from a combination of vSphere® information and VMFS information. The vSphere® information, which in some embodiments is obtained at least in part from a VMware® vCenter™ server, is used to determine which VM has which VMDK on what datastore. The VMFS information is used to determine the file system layout and to identify what VMFS blocks are used for what VMDK. In addition to VMDK volume data, there is typically additional related information, such as small link files (e.g., vmx, vmdk links, etc.) that can be extracted from the volume itself or read as files from VMware® servers.

In some embodiments, the VMFS blocks and the PowerFlex® chunks have the same size, illustratively 1 MB, and so both are allocated at 1 MB aligned boundaries.

Accordingly, in some embodiments, instead of using a list of block addresses, one could use a 1 MB chunk list to simplify the implementation.

It should be noted that the VMFS blocks have order, so it is not just a group of blocks but more specifically a particular sequence of blocks that make up a given VMDK. A list of block allocations for the given VMDK on VMFS is therefore mapped directly on a 1:1 basis to a list of PowerFlex® chunks. The list of block allocations is part of the VMFS file system structure, which illustratively utilizes Inodes, and can be read from the datastore volume itself. A simple tree walk can be used to determine the blocks that correspond to the given VMDK such that those blocks can be mapped to corresponding chunks of a PowerFlex® volume.

As indicated previously, this process is facilitated is the VMDK blocks and the PowerFlex® chunks are the same size, such as 1 MB each. However, such block/chunk alignment is not a requirement. For example, in some embodiments the VMDK blocks may be larger than the PowerFlex® chunks, in which case the mapping will map each block of the given VMDK to multiple PowerFlex® volume chunks.

VMFS is an Inode-based file system implemented in conjunction with a datastore which can comprise, for example, multiple PowerFlex® volumes. The VMDKs typically comprise respective files of this VMFS. Therefore, the Inode information for a VMDK file provides the list of blocks that make up the corresponding VMDK, which correspond to respective logical block address (LBA) offsets in the VMFS file system. In embodiments utilizing a PowerFlex® datastore, and in which the VMFS blocks and the PowerFlex® chunks have the same size, illustratively 1 MB, such that both are allocated at 1 MB aligned boundaries, the Inode information also provides the LBA offsets in the PowerFlex® volumes. However, in embodiments in which the VMFS blocks and the PowerFlex® chunks are not the same size and therefore not aligned, the LBA offsets can still be determined from the Inode information.

Referring now to FIG. 3, an illustrative embodiment configured in the exemplary manner described above is shown. In this embodiment, an information processing system 300 comprises a set of host devices that are illustratively implemented as respective ESX servers 301 denoted ESX 1, . . . ESX N. Each of the ESX servers is assumed to host at least one virtual machine, such as a first virtual machine 305-1, also denoted as VM1, that has a corresponding VMDK 311-1, also denoted as VMDK 17. The ESX servers and their associated virtual machines and VMDKs are managed by a virtual infrastructure management system server 306 that is illustratively implemented as a VMware® vCenter™ server. The VMDK 311-1 is stored in a particular one of a plurality of datastores 320, also denoted as DS1, . . . DSX. Each of these datastores 320 is assumed to comprise PowerFlex® volumes, and also includes a VMFS file system with the VMDKs of the virtual machines as files.

Also included in the system 300 is a migrator 312, which may be part of a source storage system and/or another system component, and illustratively implements migration control logic of the type described elsewhere herein.

In operation, the migrator 312 controls performance of a plurality of process steps including steps denoted as 1 through 4 in the figure.

In step 1, the migrator 312 queries the virtual infrastructure management system server 306 to determine which of the datastores 320 are utilized to store which of the VMDKs for the respective virtual machines supported by the ESX servers 301.

In step 2, the migrator 312 obtains Inode information for a particular one of the datastores 320, illustratively the datastore DSX, that includes one or more VMDKs including VMDK 17.

In step 3, the migrator determines from the obtained Inode information a mapping of blocks of the one or more VMDKs including VMDK 17 to particular allocation chunks of a PowerFlex® volume of the datastore DSX.

In step 4, the VMDK blocks of VMDK 17 are copied to a corresponding one of a plurality of target cloud volumes.

Similar processing is performed for each of a plurality of VMDKs associated with respective ones of the virtual machines supported by the ESX servers 301.

The manner in which blocks of a VMDK such as VMDK 17 are mapped to corresponding chunks of a generated PowerFlex® volume for migration to a target cloud volume will now be described with reference to FIG. 4.

FIG. 4 shows an illustrative embodiment of another example information processing system 400. The system 400 is configured with functionality for migration of virtual machine data in an illustrative embodiment. As shown in the figure, the system 400 more particularly comprises host devices 401, illustratively implemented as respective ESX servers denoted ESX 1, . . . ESX N. The ESX servers each support at least one virtual machine of a set of virtual machines 405, denoted as VM1, VM2, . . . and having associated sets of virtual machine data, illustratively including VMDK 17, . . . VMDK 142. The system 400 further includes a virtual infrastructure management system server 406 that is illustratively implemented as a VMware® vCenter™ server. Also shown in the figure is a source storage system 410S and a target storage system 410T. The source storage system 410S is configured to map blocks of a set of virtual machine data, illustratively VMDK 17, between a first storage volume, denoted as Volume 3, and a second storage volume, denoted as Volume 11, for migration to a corresponding one of a plurality of target volumes of the target storage system 410T.

It is again assumed that a datastore with VMFS is used to store the VMDKs in system 400, and that the source storage system 410S implements the datastore using PowerFlex® volumes.

Accordingly, Volume 3 as shown is a PowerFlex® volume, and stores blocks of VMDK 17 interspersed with blocks of other VMDKs. The source storage system 110S obtains Inode information for VMDK 17, which in this example includes Inode 2. The Inode information is illustratively obtained at least in part using a master file table (MFT) which indicates that Inode 2 provides the Inode information for VMDK 17. Inode 2 provides the locations of the respective blocks of VMDK 17 within Volume 3.

As illustrated, the blocks of VMDK are distributed within Volume 3 as a first portion starting with block 9 of Volume 3 and having a length of five blocks, followed by a second portion starting with block 18 of Volume 3 and having a length of three blocks, and finally a third portion starting with block 30 of Volume 3 and having a length of three blocks. These portions of blocks of VMDK 17 are arranged within Volume 3 in a non-contiguous manner but in a particular ordering relative to one another, as illustrated in the figure. The source storage system maps the blocks of VMDK 17 to chunks of Volume 11, illustratively using a one-to-one mapping of 1 MB VMDK blocks to 1 MB PowerFlex® chunks, such that the blocks of VMDK 17 are contiguously arranged in Volume 11 in a manner that preserves the particular ordering of the VMDK 17 blocks relative to one another from Volume 3.

The example Volume 11 is a PowerFlex® volume that is generated by the source storage system 410S in order to migrate VMDK 17 in an accurate and efficient manner from the source storage system 410S to a corresponding one of the target volumes in the target storage system 410T. Additional source volumes may be generated and migrated to other ones of the target volumes in a similar manner. The migration in this embodiment is assumed to be performed using a replication process, illustratively an asynchronous replication process, that is carried out between the source storage system 410S and the target storage system 410T.

Illustrative embodiments can be configured to perform online or live migration of virtual machine data, with the virtual machines in the source domain still running while the migration is in progress, or offline migration of the virtual machine data, with the VMs in the source domain being shut down for the migration.

For example, for cases in which offline migration is an option, the system 400 can be configured to shut down all virtual machine activity, migrate the generated PowerFlex® volumes from the source domain to the target domain, and then restart the virtual machine activity after the migration is complete. In some embodiments, rather than generating new volumes in the source domain for migration to the target domain, the above-described mapping information between VMDKs and PowerFlex® volumes can be provided to the target domain and used in the target domain to generate new target volumes, illustratively one per VMDK, as volumes in a PowerFlex® system in the target domain, after which applications in the target domain can be restarted on the new PowerFlex® volumes.

However, illustrative embodiments herein advantageously support online migration, which is highly important in many cases, such as for critical applications that cannot experience any significant downtime.

As indicated previously, online migration in illustrative embodiments utilizes cycle-based asynchronous replication, in which differential data between consecutive snapshots of one or more storage volumes is transferred from the source domain to the target domain over multiple cycles, although other types of migration can be used.

For example, such an asynchronous replication process may include an initial copy phase to copy all the existing virtual machine data for each virtual machine. Once that initial phase is complete, new writes that change the virtual machine data are grouped into cycles, and may initially be written to a journal. At any given moment, one cycle is collecting new writes and at the same time the differential data associated with writes from the previous cycle is being copied to the target domain. The target domain also utilizes multiple cycles, with one cycle being used to receive the differential data being copied from the source domain while at the same time the previously-received differential data associated with writes from the previous cycle are applied to the target volume.

In some embodiments, sets of virtual machine data for multiple virtual machines may be migrated together as a group. For example, this may be desirable in the case of a database that spans multiple virtual machines. In such cases, a consistency group may be formed comprising multiple VMDKs such that the cycle switch is coordinated for the VMDKs across all of the virtual machines in group.

It should be noted in this regard that online migration in some embodiments disclosed herein does not involve copying of RAM contents or other in-memory contents, as this is not a vMotion-type solution. Such a solution generally requires that the source and target domains both have the same virtualization and processor architecture, and so is not suitable for online migration of virtual machine data between distinct storage environments.

Illustrative embodiments generally involve migrating virtual machine data such as VMDKs as opposed to operating system (OS) devices. The latter often require cloud-specific conversion arrangements such as special drivers and tools, and therefore take additional time and cannot guarantee interoperability.

As VMFS is a journaling file system, embodiments that utilize VMFS are illustratively configured to flush the journal before handling the migration. This can be accomplished using one or more of the following techniques:

1. Use vmkfstool commands, which are ESX shell commands for managing VMFS volumes, storage devices, and virtual disks, or other types of analysis commands. Most analysis commands flush and check consistency when run.

2. Perform a VMDK operation at a virtual machine level, such as a prepare virtual machine snapshot operation, a prepare migration operation or virtual machine “stun” operation, all which will force a flush at the file system level.

3. Integrate directly with a VMware® journal replay manager which allows either flushing or knowing when the volume is already flushed.

4. Manually replay the appropriate journal parts when copying.

It should also be noted that a VMDK block layout may change in certain situations, such as a VMDK resizing that expands the VMDK by adding more blocks or a volume migration that moves a VMFS volume to a different datastore, and in these and other similar situations the mapping of the VMDK blocks to the PowerFlex® chunks should be updated.

The above-described processes, algorithms and other features and functionality disclosed herein are presented by way of illustrative example only, and other embodiments can utilize additional or alternative arrangements. For example, the particular types of storage environments, virtual machine data and replication processes can be varied in other embodiments. Also, depending on the particular type of replication process, at least one host device may be involved in the process.

Also, as mentioned previously, different instances of the above-described processes, algorithms and other techniques for migration of virtual machine data can be performed by different storage controllers or other components in different storage systems and for different consistency groups and associated replication processes.

Numerous alternative arrangements of these or other features can be used in implementing migration of virtual machine data in other illustrative embodiments.

It is apparent from the foregoing that illustrative embodiments disclosed herein can provide a number of significant advantages relative to conventional arrangements.

For example, some embodiments provide techniques for highly accurate and efficient migration of VMDKs or other types and arrangements of virtual machine data between distinct storage environments, such as between an enterprise storage system and a cloud-based storage system, although the disclosed techniques are more generally applicable to any of a wide variety of other storage environments.

Illustrative embodiments overcome disadvantages of conventional approaches that often require consistent storage environments and virtualization environments between source and target domains, or require use of offline migration.

In some embodiments, migration of virtual machine data between source and target storage systems is carried out in a manner that can guarantee consistency between respective source-target volume pairs.

Moreover, the disclosed techniques are applicable to a wide variety of different replication processes and associated source and target storage system configurations, including various types of distributed storage systems comprising respective sets of storage nodes.

It is to be appreciated that the particular advantages described above are associated with particular illustrative embodiments and need not be present in other embodiments. Also, the particular types of information processing system features and functionality as illustrated in the drawings and described above are exemplary only, and numerous other arrangements may be used in other embodiments.

It was noted above that portions of an information processing system as disclosed herein may be implemented using one or more processing platforms. Illustrative embodiments of such platforms will now be described in greater detail. These and other processing platforms may be used to implement at least portions of other information processing systems in other embodiments. A given such processing platform comprises at least one processing device comprising a processor coupled to a memory.

One illustrative embodiment of a processing platform that may be used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to as a multi-tenant environment. One or more system components such as virtual machines, or portions thereof, are illustratively implemented for use by tenants of such a multi-tenant environment.

Cloud infrastructure as disclosed herein can include various types of cloud-based systems. Virtual machines provided in such cloud-based systems can be used to implement a fast tier or other front-end tier of a multi-tier storage system in illustrative embodiments. A capacity tier or other back-end tier of such a multi-tier storage system can be implemented using one or more object stores.

In some embodiments, the cloud infrastructure additionally or alternatively comprises a plurality of containers illustratively implemented using respective operating system kernel control groups of one or more container host devices. For example, a given container of cloud infrastructure illustratively comprises a Docker container or other type of LXC implemented using a kernel control group. The containers may run on virtual machines in a multi-tenant environment, although other arrangements are possible. The containers may be utilized to implement a variety of different types of functionality within the system 100. For example, containers can be used to implement respective compute nodes or storage nodes of a cloud-based system. Again, containers may be used in combination with other virtualization infrastructure such as virtual machines implemented using a hypervisor.

Another illustrative embodiment of a processing platform that may be used to implement at least a portion of an information processing system comprises a plurality of processing devices which communicate with one another over at least one network. The network may comprise any type of network, including by way of example a global computer network such as the Internet, a WAN, a LAN, a satellite network, a telephone or cable network, a cellular network such as a 4G or 5G cellular network, a wireless network such as a WiFi or WiMAX network, or various portions or combinations of these and other types of networks.

Each processing device of the processing platform comprises a processor coupled to a memory. The processor may comprise a central processing unit (CPU), a microprocessor, a microcontroller, an application-specific integrated circuit (ASIC), a field-programmable gate array (FPGA), a graphics processing unit (GPU) or other type of processing circuitry, as well as portions or combinations of such circuitry elements. The memory may comprise random access memory (RAM), read-only memory (ROM), flash memory or other types of memory, in any combination. The memory and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals.

Also included in the processing device is network interface circuitry, which is used to interface the processing device with the network and other system components, and may comprise conventional transceivers.

As another example, portions of a given processing platform in some embodiments can comprise converged infrastructure.

Again, these particular processing platforms are presented by way of example only, and other embodiments may include additional or alternative processing platforms, as well as numerous distinct processing platforms in any combination, with each such platform comprising one or more computers, servers, storage devices or other processing devices.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in an information processing system as disclosed herein. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality of the virtual machines 105, hypervisors 106 and source and target storage systems 110 and associated logic instances of system 100 are illustratively implemented in the form of software running on one or more processing devices. As a more particular example, the instances of migration control logic 112 may be implemented at least in part in software, as indicated previously herein.

It should again be emphasized that the above-described embodiments are presented for purposes of illustration only. Many variations and other alternative embodiments may be used. For example, the disclosed techniques are applicable to a wide variety of other types of information processing systems, utilizing other arrangements of domains, host devices, networks, virtual machines, hypervisors, virtual machine management logic instances, source and target storage systems, virtual disks, migration control logic instances, and additional or alternative components.

Also, the particular configurations of system and device elements and associated processing operations illustratively shown in the drawings can be varied in other embodiments. For example, a wide variety of different host device and storage system configurations, and associated migration of virtual machine data techniques, can be used in other embodiments. Moreover, the various assumptions made above in the course of describing the illustrative embodiments should also be viewed as exemplary rather than as requirements or limitations. Numerous other alternative embodiments within the scope of the appended claims will be readily apparent to those skilled in the art.

What is claimed is:

1. An apparatus comprising:
at least one processing device comprising a processor coupled to a memory;
said at least one processing device being configured:
to obtain index node information for a set of virtual machine data of a particular virtual machine in a source domain comprising a source storage system;
to utilize the index node information to identify locations of respective blocks of the set of virtual machine data among other blocks present in a first storage volume of the source storage system;
to map the blocks of the set of virtual machine data to a second storage volume of the source storage system based at least in part on their respective locations in the first storage volume; and
to migrate the second storage volume comprising the mapped blocks of the set of virtual machine data to a target storage system of a target domain.

2. The apparatus of claim 1 wherein said at least one processing device comprises at least a portion of the source storage system.

3. The apparatus of claim 1 wherein said at least one processing device comprises at least a portion of a host device coupled to at least one of the source storage system and the target storage system.

4. The apparatus of claim 1 wherein at least portions of the blocks of the set of virtual machine data are arranged in the first storage volume in a non-contiguous manner but in a particular ordering relative to one another, and further wherein all of the blocks of the set of virtual machine data are arranged in the second storage volume in a contiguous manner and are also arranged in the second storage volume in a manner that preserves the particular ordering of the blocks relative to one another from the first storage volume.

5. The apparatus of claim 1 wherein the set of virtual machine data for the particular virtual machine comprises a virtual machine disk (VMDK) of the particular virtual machine.

6. The apparatus of claim 1 wherein the first storage volume is configured in accordance with a virtual machine file system (VMFS) of the source storage system and includes the blocks of the set of virtual machine data interspersed with blocks of one or more other sets of virtual machine data of other virtual machines in the source domain.

7. The apparatus of claim 1 wherein migrating the second storage volume comprising the mapped blocks of the set of virtual machine data to the target storage system of the target domain comprises configuring a replication process to replicate the second storage volume comprising the mapped blocks of the set of virtual machine data to an additional storage volume of the target storage system of the target domain.

8. The apparatus of claim 7 wherein the replication process comprises a cycle-based asynchronous replication process in which differential data between consecutive snapshots of the second storage volume is replicated to the additional storage volume for each of a plurality of cycles.

9. The apparatus of claim 1 wherein the blocks of the set of virtual machine data have a first block size in the first storage volume and are mapped on a one-to-one basis to respective corresponding blocks of the same block size in the second storage volume.

10. The apparatus of claim 1 wherein the at least one processing device is further configured:
to detect a condition indicative of a change in a block layout of the blocks of the set of virtual machine data in the first storage volume; and
to repeat at least a portion of the obtaining, utilizing, mapping and migrating responsive to the detected condition.

11. The apparatus of claim 1 wherein the obtaining, utilizing, mapping and migrating are repeated for each of one or more additional sets of virtual machine data of one or more respective additional virtual machines in the source domain comprising the source storage system, and further wherein instances of the second storage volume corresponding to respective ones of the sets of virtual machine data collectively form at least a portion of a consistency group for migration to the target storage system of the target domain.

12. A computer program product comprising a non-transitory processor-readable storage medium having stored therein program code of one or more software programs, wherein the program code, when executed by at least one processing device comprising a processor coupled to a memory, causes said at least one processing device:
to obtain index node information for a set of virtual machine data of a particular virtual machine in a source domain comprising a source storage system;
to utilize the index node information to identify locations of respective blocks of the set of virtual machine data among other blocks present in a first storage volume of the source storage system;
to map the blocks of the set of virtual machine data to a second storage volume of the source storage system based at least in part on their respective locations in the first storage volume; and
to migrate the second storage volume comprising the mapped blocks of the set of virtual machine data to a target storage system of a target domain.

13. The computer program product of claim 12 wherein at least portions of the blocks of the set of virtual machine data are arranged in the first storage volume in a non-contiguous manner but in a particular ordering relative to one another, and further wherein all of the blocks of the set of virtual machine data are arranged in the second storage volume in a contiguous manner and are also arranged in the second storage volume in a manner that preserves the particular ordering of the blocks relative to one another from the first storage volume.

14. The computer program product of claim 12 wherein migrating the second storage volume comprising the mapped blocks of the set of virtual machine data to the target storage system of the target domain comprises configuring a replication process to replicate the second storage volume comprising the mapped blocks of the set of virtual machine data to an additional storage volume of the target storage system of the target domain.

15. The computer program product of claim 14 wherein the replication process comprises a cycle-based asynchronous replication process in which differential data between consecutive snapshots of the second storage volume is replicated to the additional storage volume for each of a plurality of cycles.

16. A method comprising:
obtaining index node information for a set of virtual machine data of a particular virtual machine in a source domain comprising a source storage system;
utilizing the index node information to identify locations of respective blocks of the set of virtual machine data among other blocks present in a first storage volume of the source storage system;
mapping the blocks of the set of virtual machine data to a second storage volume of the source storage system based at least in part on their respective locations in the first storage volume; and
migrating the second storage volume comprising the mapped blocks of the set of virtual machine data to a target storage system of a target domain;
wherein the method is performed by at least one processing device comprising a processor coupled to a memory.

17. The method of claim 16 wherein at least portions of the blocks of the set of virtual machine data are arranged in the first storage volume in a non-contiguous manner but in a particular ordering relative to one another, and further wherein all of the blocks of the set of virtual machine data are arranged in the second storage volume in a contiguous manner and are also arranged in the second storage volume in a manner that preserves the particular ordering of the blocks relative to one another from the first storage volume.

18. The method of claim 16 wherein migrating the second storage volume comprising the mapped blocks of the set of virtual machine data to the target storage system of the target domain comprises configuring a replication process to replicate the second storage volume comprising the mapped blocks of the set of virtual machine data to an additional storage volume of the target storage system of the target domain.

19. The method of claim 18 wherein the replication process comprises a cycle-based asynchronous replication process in which differential data between consecutive snapshots of the second storage volume is replicated to the additional storage volume for each of a plurality of cycles.

20. The method of claim 16 wherein the obtaining, utilizing, mapping and migrating are repeated for each of one or more additional sets of virtual machine data of one or more respective additional virtual machines in the source domain comprising the source storage system, and further wherein instances of the second storage volume corresponding to respective ones of the sets of virtual machine data collectively form at least a portion of a consistency group for migration to the target storage system of the target domain.
